(19) United States
(12) Patent Application Publication
(10) Pub. No.: US 2016/0273421 A1
(43) Pub. Date: Sep. 22, 2016

(54) OIL PUMP DRIVING CONTROL APPARATUS

(71) Applicant: AISIN SEIKI KABUSHIKI KAISHA, Kariya-shi (JP)

(72) Inventor: Hirohito TERASHIMA, Anjo-shi, Aichi-ken (JP)

(73) Assignee: AISIN SEIKI KABUSHIKI KAISHA, Kariya-shi, Aichi-ken (JP)

(21) Appl. No.: 14/777,726

(22) PCT Filed: Mar. 4, 2014
(86) PCT No.: PCT/JP2014/055468

§ 371 Date: Sep. 16, 2015

(30) Foreign Application Priority Data
May 29, 2013 (JP) 2013-112625

(51) Int. Cl. F01M 1/02; H02J 7/14; B60R 16/033; F01M 11/10; F01M 1/16

(52) U.S. Cl. CPC F01M 1/02; F01M 11/10; F01M 1/16; B60R 16/033; H02J 7/14; F01M 2001/0215; F01M 2001/0253; F01M 2250/60

(57) ABSTRACT

The oil pump driving control apparatus includes an internal combustion engine driving source transmitting a driving force of an internal combustion engine to an oil pump that includes an inner rotor and an outer rotor, a motor separately provided from the internal combustion engine driving source and driving and rotating the oil pump, and a driving source switching portion switching a driving source of the oil pump to at least one of the motor and the internal combustion engine driving source based on an oil temperature and a rotation number of the internal combustion engine.

### TECHNICAL FIELD

This invention relates to an oil pump driving control apparatus.

### BACKGROUND ART

Conventionally, a known oil pump driving control apparatus includes both a motor and an internal combustion engine driving source which utilizes a driving force of an internal combustion engine, each of the motor and the internal combustion engine driving source serving as a driving source for rotating and driving an oil pump. Such oil pump driving control apparatus is disclosed, for example, in JP4948204B.

In JP4948204B, an oil pump driving control apparatus including a drive mechanism that drives an oil pump by a driving force of an engine (internal combustion engine), an electric motor that drives the oil pump, an oil temperature detection portion detecting an oil temperature, and a selective driving means switching a driving source of the oil pump to either the drive mechanism or the motor based on the oil temperature detected by the oil temperature detection portion.

### DOCUMENT OF PRIOR ART

### Patent Document

Patent document 1: JP4948204B

### OVERVIEW OF INVENTION

### Problem to be Solved by Invention

According to JP4948204B, however, the driving source of the oil pump is switched to either the drive mechanism or the motor based on only the oil temperature detected by the oil temperature detection portion. Thus, even in a case where the rotation number of the internal combustion engine increases and therefore an oil discharge rate is required to increase, the oil pump is driven by the motor as long as a predetermined oil temperature specified for driving the oil pump by the motor is obtained. In this case, in order to achieve a necessary oil discharge rate, a high-power motor that achieves a high revolution is required.

The present invention is made to solve the drawback such as mentioned above and one object of the invention is to provide an oil pump driving control apparatus that achieves a desired oil discharge rate without a usage of a high-power motor that achieves a high revolution.

### Means for Solving Problem

In order to achieve the aforementioned object, an oil pump driving control apparatus according to one aspect of the present invention includes an internal combustion engine driving source transmitting a driving force of an internal combustion engine to an oil pump that includes an inner rotor and an outer rotor, a motor separately provided from the internal combustion engine driving source and driving and rotating the oil pump, an oil temperature detection portion detecting an oil temperature, a rotation number detection portion detecting a rotation number of the internal combustion engine, and a driving source switching portion switching a driving source of the oil pump to at least one of the motor and the internal combustion engine driving source based on the oil temperature detected by the oil temperature detection portion and the rotation number of the internal combustion engine detected by the rotation number detection portion.

In the oil pump driving control apparatus according to the aspect of the present invention, as mentioned above, the driving source switching portion is provided for switching the driving source of the oil pump to at least one of the motor and the internal combustion engine driving source based on the oil temperature detected by the oil temperature detection portion and the rotation number of the internal combustion engine detected by the rotation number detection portion. In a case where the rotation number of the internal combustion engine increases so that an oil discharge rate is required to increase, the oil pump is switched to be driven by the internal combustion engine driving source based on not only the oil temperature but also the rotation number of the internal combustion engine even with the oil temperature specified for driving the oil pump by the motor. Thus, the driving force of the internal combustion engine including the high rotation number is transmitted to the oil pump through the internal combustion engine driving source and the oil pump is driven. Without a usage of a high-power motor that achieves a high revolution, a desired oil discharge rate may be achieved. In addition, in a case where the oil temperature is low and oil viscosity is high such as at a start of the internal combustion engine, for example, the oil pump is switched to be driven by the internal combustion engine driving source based on the oil temperature and the rotation number of the internal combustion engine. Without a usage of a high-torque motor, the desired oil discharge rate is obtainable.

In the oil pump driving control apparatus according to the aforementioned aspect, favorably, the driving source switching portion is configured to switch the driving source of the oil pump to the motor in at least one of cases where the oil temperature detected by the oil temperature detection portion is greater than a predetermined temperature and where the rotation number of the internal combustion engine detected by the rotation number detection portion is smaller than a predetermined rotation number. According to the aforementioned construction, when the driving source of the oil pump is switched to the motor in a case where the oil temperature is greater than the predetermined temperature, the oil pump may be driven by the motor in a state where the oil temperature is greater than the predetermined temperature and the oil viscosity is lower than a predetermined viscosity. The oil pump may be effectively driven without a large load applied to the motor. In addition, when the driving source of the oil pump is switched to the motor in a case where the rotation number of the internal combustion engine is smaller than the predetermined rotation number, the oil pump may be effectively driven within an output range of the motor which is effective at a time of low rotation and high output power.

In this case, favorably, in a case where the driving source of the oil pump is switched to the motor by the driving source switching portion, a rotation number of the motor is configured to be determined on a basis of the oil temperature detected by the oil temperature detection portion and the rotation number of the internal combustion engine detected by the rotation number detection portion. According to the aforementioned construction, the oil discharge rate depending on the detected oil temperature and the detected rotation number of the internal combustion engine may be effectively achieved by the driving of the motor.

The oil pump driving control apparatus according to the aforementioned aspect, favorably, further includes an oil pressure detection portion detecting an oil pressure, and the driving source switching portion is configured to switch the driving source of the oil pump to at least one of the motor and the internal combustion engine driving source based on the oil temperature detected by the oil temperature detection portion, the rotation number of the internal combustion engine detected by the rotation number detection portion and the oil pressure detected by the oil pressure detection portion. According to the aforementioned construction, the driving of the oil pump is switched on a basis of the detected oil pressure in addition to the detected oil temperature and the detected rotation number of the internal combustion engine. The change in viscosity resulting from oil difference or degradation of oil, for example, is detectable on a basis of the oil pressure. As a result, the driving of the oil pump suitable for the state of the oil may be performed.

In the oil pump driving control apparatus according to the aforementioned aspect, favorably, the driving source switching portion is configured to switch the driving source of the oil pump to the motor in at least one of cases where the oil temperature detected by the oil temperature detection portion is greater than a predetermined temperature, where the rotation number of the internal combustion engine detected by the rotation number detection portion is smaller than a predetermined rotation number and where the oil pressure detected by the oil pressure detection portion is smaller than a predetermined oil pressure. According to the aforementioned construction, when the driving source of the oil pump is switched to the motor in a case where the oil pressure is smaller than the predetermined oil pressure, the oil pump may be effectively driven within the effective output range of the motor depending on the state of the oil. In addition, when the driving source of the oil pump is switched to the motor in a case where the oil temperature is greater than the predetermined temperature, the oil pump may be driven by the motor without a large load applied to the motor in a state where the oil temperature is greater than the predetermined temperature and the oil viscosity is smaller than the predetermined viscosity. The oil pump may be thus effectively driven. Further, when the driving source of the oil pump is switched to the motor in a case where the rotation number of the internal combustion engine is smaller than the predetermined rotation number, the oil pump may be effectively driven within the effective output range of the motor.

In this case, favorably, in a case where the driving source of the oil pump is switched to the motor by the driving source switching portion, a rotation number of the motor is configured to be determined on a basis of the oil temperature detected by the oil temperature detection portion, the rotation number of the internal combustion engine detected by the rotation number detection portion and the oil pressure detected by the oil pressure detection portion. According to the aforementioned construction, the oil discharge rate depending on the detected oil temperature, the detected rotation number of the internal combustion engine and the detected oil pressure may be effectively achieved by the driving of the motor.

In the aforementioned construction where the rotation number of the motor is determined on a basis of the oil temperature, the rotation number of the internal combustion engine and the oil pressure, favorably, a load detection portion detecting a load of the internal combustion engine is further provided, and the rotation number of the motor is configured to be determined on a basis of the oil temperature detected by the oil temperature detection portion, the rotation number of the internal combustion engine detected by the rotation number detection portion, the oil pressure detected by the oil pressure detection portion and the load of the internal combustion engine detected by the load detection portion. According to the aforementioned construction, the oil discharge rate depending on the detected oil temperature, the detected rotation number of the internal combustion engine, the detected oil pressure and the detected load of the internal combustion engine may be effectively achieved by the driving of the motor. The load detection portion that detects the load of the internal combustion engine includes a detection portion detecting an accelerator opening degree, a throttle opening degree, a valve lift amount or a fuel injection amount.

In the oil pump driving control apparatus according to the aforementioned aspect, favorably, at least one of the driving force of the internal combustion engine driving source and a driving force of the motor is configured to be transmitted to the inner rotor of the oil pump. According to the aforementioned construction, at least one of the driving forces of the motor and the internal combustion engine driving source may be transmitted to the inner rotor to drive the oil pump. In addition, a size in a radial direction of a transmission mechanism may be reduced to expect a downsizing of the oil pump driving control apparatus.

In this case, favorably, the motor is constantly connected to the inner rotor to rotate with the inner rotor of the oil pump. In addition, the driving force of the internal combustion engine driving source is configured to be transmitted to the inner rotor through the motor in a case where the driving force of the internal combustion engine driving source is switched to be transmitted to the inner rotor by the driving source switching portion. Further, the driving force of the motor is configured to be directly transmitted to the inner rotor without through the internal combustion engine driving source in a case where the driving force of the motor is switched to be transmitted to the inner rotor by the driving source switching portion. According to the aforementioned construction, in a case where the driving force of the motor is switched to be transmitted to the inner rotor, the driving of the internal combustion engine driving source is inhibited from being transmitted to the inner rotor and only the driving force of the motor is transmitted to the inner rotor. Thus, the oil pump may be driven by the motor regardless of the rotation number of the internal combustion engine. In addition, in a case where the driving force of the internal combustion engine driving source is switched to be transmitted to the inner rotor, the driving of the internal combustion engine driving source is transmitted to the inner rotor through the motor. Thus, the oil pump may be driven by the driving force from the internal combustion engine which is adjusted with the driving force by the motor. Accordingly, the oil pump may be effectively driven.

In the oil pump driving control apparatus according to the aforementioned aspect, favorably, the driving source switching portion includes a hydraulic driving source switching mechanism. According to the aforementioned construction, the driving source of the oil pump is switchable by a control for turning on and off the oil pressure, which simplifies the switching control.

In this case, favorably, the driving source switching mechanism includes a control valve that turns on and off an oil pressure from the oil pump, and the driving source of the oil pump is configured to be switched to at least one of the motor and the internal combustion engine driving source by a control for turning on and off the oil pressure by the control valve. According to the aforementioned construction, the driving source of the oil pump is switched to at least one of the motor and the internal combustion engine driving source by the control for turning on and off the oil pressure by the control valve. Thus, timing at which the driving source is switched may be arbitrarily specified.

In the oil pump driving control apparatus according to the aforementioned aspect, favorably, in a case where the driving source of the oil pump is switched to the internal combustion engine driving source by the driving source switching portion, the motor is configured to generate an electric power by being rotated together with the oil pump by the internal combustion engine driving source. According to the aforementioned construction, the motor rotating (led to rotate) in association with the driving of the oil pump by the internal combustion engine driving source is usable as a generator. A mechanical energy by the internal combustion engine driving source is partially recovered as an electric energy by the motor, and the electric energy that is recovered may be effectively used as a driving electric power for other equipment.

In the oil pump driving control apparatus according to the aforementioned aspect, favorably, the driving source switching portion includes an engagement member engageable with the internal combustion engine driving source and the motor, the engagement member being configured to be switched to a first engagement state in which one of the driving forces of the motor and the internal combustion engine driving source is transmitted to the oil pump and to a second engagement state in which the other of the driving forces of the motor and the internal combustion engine driving source is transmitted to the oil pump. According to the aforementioned construction, the engagement state of the engagement member is switched to easily switch the driving source of the oil pump to either the internal combustion engine driving source or the motor.

In this case, favorably, the motor is constantly connected to the oil pump, and the driving force of the motor is configured to be transmitted to the oil pump without through the engagement member in the first engagement state in which the engagement member engages with the internal combustion engine driving source and disengages from the motor. In addition, the driving force of the internal combustion engine driving source is configured to be transmitted to the oil pump through the engagement member and the motor in the second engagement state in which the engagement member engages with both the motor and the internal combustion engine driving source. According to the aforementioned construction, in the first engagement state, the driving of the internal combustion engine driving source is inhibited from being transmitted to the oil pump and only the driving force of the motor is transmitted to the oil pump. Regardless of the rotation number of the internal combustion engine, the oil pump may be driven by the motor. In addition, in the second engagement state, the driving of the internal combustion engine driving source is transmitted to the oil pump through the motor. The oil pump may be thus driven by the driving force from the internal combustion engine which is adjusted with the driving force by the motor. Accordingly, the oil pump may be effectively driven.

In the oil pump driving control apparatus according to the aforementioned aspect, favorably, in a case where the driving source of the oil pump is switched from the internal combustion engine driving source to the motor by the driving source switching portion, the driving source of the oil pump is configured to be switched to the motor after the motor is driven to rotate. According to the aforementioned construction, upon switching of the driving source, the motor is driven to rotate so as to follow the rotation number of a rotation shaft of the internal combustion engine driving source. A load applied between the rotation shaft of the internal combustion engine driving source and a rotation shaft of the motor may be reduced, thereby smoothly switching the driving source of the oil pump from the internal combustion engine driving source to the motor.

In the present application, other than the oil pump driving control apparatus according to the aforementioned aspect, the other construction is considered as below.

An oil pump driving control apparatus according to the other construction of the present application includes an internal combustion engine driving source transmitting a driving force of an internal combustion engine to an oil pump that includes an inner rotor and an outer rotor, a motor separately provided from the internal combustion engine driving source and driving and rotating the oil pump, an oil temperature detection portion detecting an oil temperature, an oil pressure detection portion detecting an oil pressure, and a driving source switching portion switching a driving source of the oil pump to at least one of the motor and the internal combustion engine driving source based on the oil temperature detected by the oil temperature detection portion and the oil pressure detected by the oil pressure detection portion. According to the aforementioned construction, the oil viscosity is detectable on a basis of not only the oil temperature but also the oil pressure. Thus, when the switching is made so that the oil pump is driven by the internal combustion engine driving source in a case where the oil temperature is low and the oil viscosity is high (for example, at the start of the internal combustion engine) or the oil temperature and the oil pressure are high (for example, at the high rotation of the internal combustion engine), the driving force of the internal combustion engine with large torque is transmitted to the oil pump through the internal combustion engine driving source to drive the oil pump. Without a usage of a high-torque motor, a desired oil discharge rate is achievable.

In the oil pump driving control apparatus according to the aforementioned aspect or the other construction, the driving source switching portion includes an electromagnetic driving source switching mechanism. According to the aforementioned construction, the driving source of the oil pump is easily switchable by the electromagnetic driving source switching mechanism.

### Effects of the Invention

According to the aforementioned aspect of the present invention, as mentioned above, a desired oil discharge rate may be achieved without a usage of a high-power motor that achieves a high revolution.

### BRIEF DESCRIPTION OF DRAWINGS

FIG. 1 A block diagram illustrating a construction of an oil pump driving control apparatus according to a first embodiment of the present invention;

FIG. 2 A cross-sectional view illustrating a case where an OSV of the oil pump driving control apparatus according to the first embodiment of the present invention is in an OFF state;

FIG. 3 A cross-sectional view illustrating a case where the OSV of the oil pump driving control apparatus according to the first embodiment of the present invention is in an ON state;

FIG. 4 A cross-sectional view taken along line IV-IV in FIG. 2;

FIG. 5 A diagram illustrating driving regions of a motor and an internal combustion engine driving source of the oil pump driving control apparatus according to the first embodiment of the present invention;

FIG. 6 A flowchart for explaining a driving source switching process by a motor control portion of the oil pump driving control apparatus according to the first embodiment of the present invention;

FIG. 7 A block diagram illustrating a construction of an oil pump driving control apparatus according to a second embodiment of the present invention; and

FIG. 8 A flowchart for explaining the driving source switching process by the motor control portion of the oil pump driving control apparatus according to the second embodiment of the present invention.

### MODE FOR CARRYING OUT THE INVENTION

Embodiments of the present invention are explained on a basis of the attached drawings.

### First Embodiment

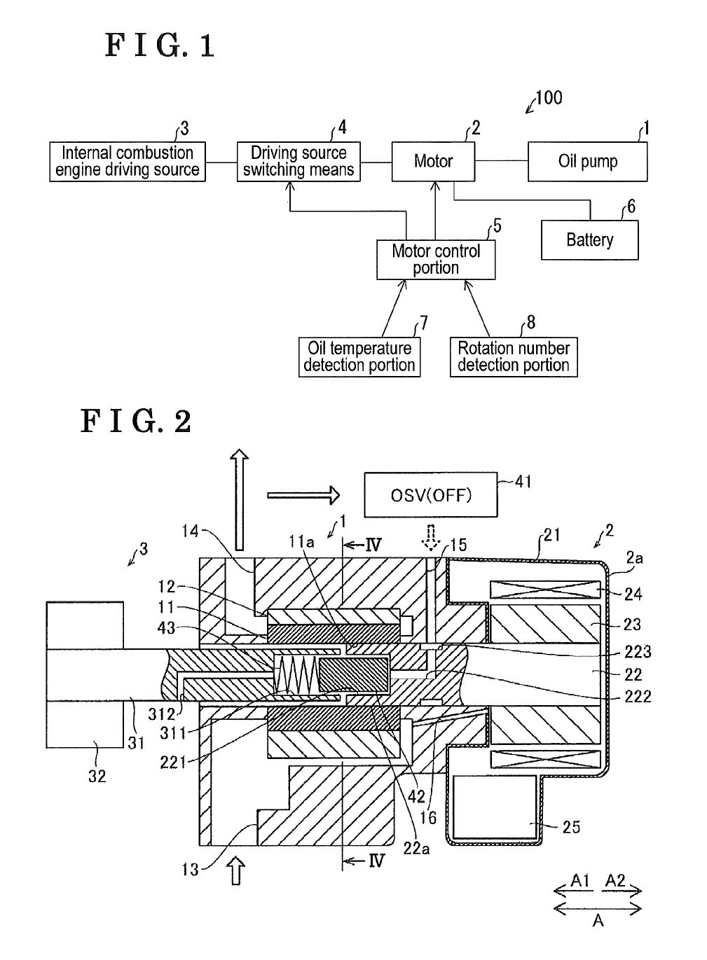

A construction of an oil pump driving control apparatus 100 according to a first embodiment of the present invention is explained with reference to FIGS. 1 to 5.

The oil pump driving control apparatus 100 is mounted to an automobile (not illustrated) and is configured to supply and circulate an engine oil to an internal combustion engine (engine) of the automobile. In addition, as illustrated in FIG. 1, the oil pump driving control apparatus 100 includes an oil pump 1, a motor 2, an internal combustion engine driving source 3, a driving source switching means 4, a motor control portion 5, a battery 6, an oil temperature detection portion 7 and a rotation number detection portion 8. The driving source switching means 4 is an example of a driving source switching portion of the present invention.

As illustrated in FIGS. 2 and 4, the oil pump 1 includes an inner rotor 11 and an outer rotor 12. In addition, as illustrated in FIG. 2, the oil pump 1 includes an intake portion 13, a discharge portion 14, a switch oil passage 15 and an oil returning portion 16.

As illustrated in FIG. 2, the motor 2 includes a housing 21, a motor shaft 22, a rotor portion 23, a stator portion 24 and a connector 25. In addition, an engagement hole 221, a switch oil passage 222 and a groove portion 223 are formed at the motor shaft 22.

As illustrated in FIG. 2, the internal combustion engine driving source 3 includes a drive shaft 31 and a drive transmission mechanism 32. An engagement hole 311 and an oil returning portion 312 are formed at the drive shaft 31.

As illustrated in FIG. 2, the driving source switching means 4 includes an OSV (oil switching valve) 41 serving as a hydraulic driving source switching mechanism, an engagement member 42 and a spring member 43 formed by a compression coil spring. The OSV 41 is an example of the driving source switching mechanism and a control valve of the present invention.

The oil pump 1 is configured to pump the engine oil from an oil pan (not illustrated) to supply the engine oil to the internal combustion engine via an oil filter (not illustrated). Specifically, the oil pump 1 is configured to pump the engine oil from the intake portion 13 and to discharge the engine oil from the discharge portion 14. In addition, as illustrated in FIG. 4, the oil pump 1 is constituted by a trochoidal-type oil pump. That is, the oil pump 1 is configured to suction and discharge the oil based on changes in void capacity that is generated by a rotation difference between a rotation of the inner rotor 11 and a rotation of the outer rotor 12.

In the oil pump 1 as illustrated in FIG. 2, an outer side surface 22a of the motor shaft 22 of the motor 2 is connected to a surface of a penetration bore 11a at a center of the inner rotor 11. In addition, the oil pump 1 is configured so that the inner rotor 11 is driven to rotate by at least one of the motor 2 and the internal combustion engine driving source 3. In association with the rotation of the inner rotor 11, the outer rotor 12 is rotated.

The switch oil passage 15 is formed so that the oil controlled by the driving source switching means 4 (OSV 41) flows through the switch oil passage 15. The oil returning portion 16, which serves as a passage connecting an inner portion of the housing 21 of the motor 2 and the intake portion 13, is provided to return the oil accumulated at the inner portion of the housing 21 to the intake portion 13 (i.e., to cause the oil accumulated at the inner portion of the housing 21 to be suctioned by the intake portion 13).

The motor 2 is configured to drive the oil pump 1 by driving and rotating the inner rotor 11. In addition, the motor 2 is constantly connected to the inner rotor 11 so as to rotate together with the inner rotor 11. That is, the motor 2 is constantly connected to the oil pump 1. In addition, the motor 2 is configured to generate an electric power by being rotated together with the oil pump 1 by the internal combustion engine driving source 3 in a case where the driving source of the oil pump 1 is switched to the internal combustion engine driving source 3 by the driving source switching means 4. The electric power generated by the motor 2 is configured to be charged at the battery 6 (see FIG. 1) via the connector 25.

The housing 21 houses a motor body portion 2a (the rotor portion 23 and the stator portion 24) and the connector 25. The motor body portion 2a is arranged at one side (i.e., side in a direction A2) of the oil pump 1 in an axial direction relative to the oil pump 1.

The motor shaft 22 is configured to extend towards the oil pump 1. An end portion of the motor shaft 22 at the side in the direction A2 is connected to the rotor portion 23 so that the motor shaft 22 is configured to rotate together with the rotor portion 23. In addition, the outer side surface 22a of an end portion of the motor shaft 22 facing the oil pump 1 (i.e., at a side in a direction A1) is connected to the inner rotor 11 of the oil pump 1. The engagement hole 221 in a substantially hexagonal shape is formed at the end portion of the motor shaft 22 facing the oil pump 1. The engagement member 42 of the driving source switching means 4 is configured to be engageable with the engagement hole 221.

The switch oil passage 222 formed at the inner portion of the motor shaft 22 is configured so that the oil controlled by the driving source switching means 4 (OSV 41) flows through the switch oil passage 222. In addition, the switch oil passage 222 is configured to connect the engagement hole 221 and the switch oil passage 15 of the oil pump 1. The groove portion 223 is formed along an outer periphery of the motor shaft 22 at a boundary between the switch oil passage 15 of the oil pump 1 and the switch oil passage 222. Accordingly, regardless of a rotation position of the motor shaft 22, the oil controlled by the driving source switching means 4 (OSV 41) is configured to flow through the switch oil passage 222.

A permanent magnet (not illustrated) is disposed at the rotor portion 23 which is configured to rotate together with the motor shaft 22. The stator portion 24, which includes a winding wire, is configured to rotate the rotor portion 23 by the winding wire being supplied with three-phase alternating current power supply. The connector 25 is configured to supply the power which is supplied from the outside to the stator portion 24. In addition, the connector 25 is configured to convert the electric power that is generated by the motor 2 from an alternating current to a direct current and to output the resulting power to the battery 6.

The internal combustion engine driving source 3 is configured to transmit the driving force of the internal combustion engine (engine) to the inner rotor 11 of the oil pump 1 so as to drive and rotate the inner rotor 11. Specifically, the internal combustion engine driving source 3 is configured to transmit the driving force to the inner rotor 11 through the engagement member 42 and the motor shaft 22 of the motor 2 to drive the oil pump 1.

The drive shaft 31 is configured to transmit the driving force of the internal combustion engine (engine) to the oil pump 1 via the drive transmission mechanism portion 32. The drive shaft 31 is configured to extend towards the oil pump 1 (in the direction A2). The drive shaft 31 is arranged coaxially facing the motor shaft 22. The engagement hole 311 in a substantially hexagonal shape is formed at an end portion of the drive shaft 31 facing the oil pump 1. The engagement member 42 of the driving source switching means 4 is configured to be engageable with the engagement hole 311.

An oil discharge passage 312 formed at an inner portion of the drive shaft 31 is connected to the engagement hole 311 so that the oil at the engagement hole 311 is configured to be discharged to the outside. Specifically, in an ON state of the OSV 41 of the driving source switching means 4, the engagement member 42 moves towards the internal combustion engine driving source 3 (in the direction A1) so that the oil at the engagement hole 311 is discharged to the outside via the oil discharge passage 312.

The drive transmission mechanism portion 32, which includes a gear or a sprocket, is configured to transmit the driving force of the internal combustion engine to the drive shaft 31. In addition, the drive transmission mechanism portion 32 is arranged at the other side (i.e., side in the direction A1) of the oil pump 1 in the axial direction relative to the oil pump 1.

Here, in the first embodiment, the driving source switching means 4 is configured to switch the driving source of the oil pump 1 to at least one of the motor 2 and the internal combustion engine driving source 3 based on an oil temperature detected by the oil temperature detection portion 7 and a rotation number of the internal combustion engine detected by the rotation number detection portion 8. Specifically, the driving source switching means 4 is configured to switch the driving source of the oil pump 1 to the motor 2 in a case where the oil temperature detected by the oil temperature detection portion 7 is greater than a predetermined temperature (for example, 80° C.) and the rotation number of the internal combustion engine detected by the rotation number detection portion 8 is smaller than a predetermined rotation number (for example, 4000 rpm).

The OSV 41 of the driving source switching means 4 is configured to turn on and off an application of an oil pressure from the oil pump 1 by the control of the motor control portion 5. The engagement member 42 of the driving source switching means 4 is configured to be engageable with the internal combustion engine driving source 3 and the motor 2. As illustrated in FIG. 4, the engagement member 42 includes a hexagonally-shaped cross section. The spring member 43 of the driving source switching means 4 is configured to bias the engagement member 42 in the direction A2 opposite from the direction A1 in which the oil pressure is applied to the engagement member 42 at the time of a turn-on control of the oil pressure by the OSV 41.

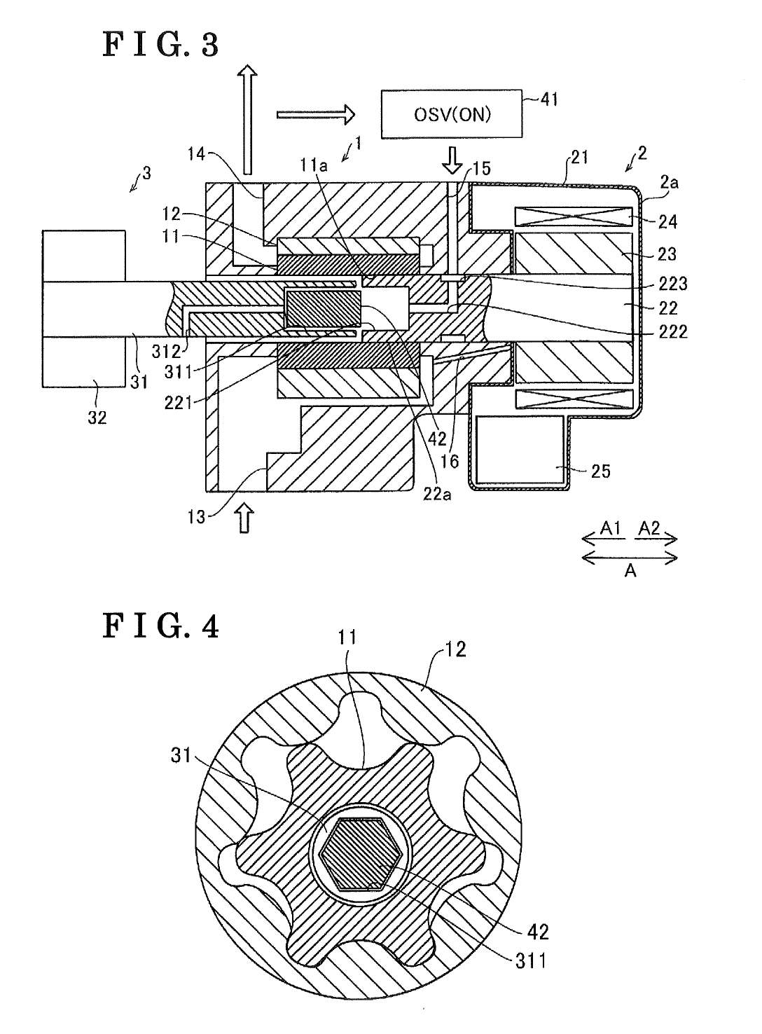

The driving source switching means 4 is configured to switch the driving source to at least one of the motor 2 and the internal combustion engine driving source 3 to drive the inner rotor 11 by the OSV 41 that controls turning on and off of the application of the oil pressure. Specifically, the engagement member 42 of the driving source switching means 4 is switched to a first engagement state where the driving force of the motor 2 is transmitted to the inner rotor 11 at the time of the turn-on control of the oil pressure by the OSV 41 (see FIG. 3). The engagement member 42 of the driving source switching means 4 is switched to a second engagement state where the driving force of the internal combustion engine driving source 3 is transmitted to the inner rotor 11 at the time of a turn-off control of the oil pressure by the OSV 41 (see FIG. 2).

That is, in the first engagement state as illustrated in FIG. 3, the engagement member 42 engages with the internal combustion engine driving source 3 and disengages from the motor 2 so that the driving force of the motor 2 is transmitted to the inner rotor 11 without through the engagement member 42. In addition, in the second engagement state as illustrated in FIG. 2, the engagement member 42 engages with both the motor 2 and the internal combustion engine driving source 3 so that the driving force of the internal combustion engine driving source 3 is transmitted to the inner rotor 11 through the engagement member 42 and the motor shaft 22.

The engagement member 42 is configured to engage with the motor shaft 22 and the drive shaft 31 so that the driving force is transmittable thereto and to switch the engagement state relative to the motor shaft 22 and the drive shaft 31 based on the first engagement state and the second engagement state. Specifically, at the turn-on control of the oil pressure by the OSV 41 as illustrated in FIG. 3, the engagement member 42 is configured to move in the direction A1 against the biasing force of the spring member 43 by the oil pressure so as to be switched to the first engagement state. In addition, at the turn-off control of the oil pressure by the OSV 41 as illustrated in FIG. 2, the engagement member 42 is configured to move in the direction A2 by the biasing force of the spring member 43 so as to be switched to the second engagement state.

In the first engagement state (see FIG. 3) where the switching is made by the driving source switching means 4 so that the driving force of the motor 2 is transmitted to the inner rotor 11 (oil pump 1), the driving force of the motor 2 is configured to be directly transmitted to the inner rotor 11 (oil pump 1) without through the internal combustion engine driving source 3. That is, in the first engagement state, only the driving force of the motor 2 is transmitted to the inner rotor 11. In the second engagement state (see FIG. 2) where the switching is made by the driving source switching means 4 so that the driving force of the internal combustion engine driving source 3 is, transmitted to the inner rotor 11 (oil pump 1), the driving force of the internal combustion engine driving source 3 is configured to be transmitted to the inner rotor 11 (oil pump 1) through the motor shaft 22 (motor 2). That is, in the second engagement state, as long as the driving force of the motor 2 is zero, it is configured that only the driving force of the internal combustion engine driving source 3 is transmitted to the inner rotor 11 and that the motor 2 generates the electric power while being rotated together with the inner rotor 11 (oil pump 1) by the internal combustion engine driving source 3. In the second engagement state, when the motor 2 generates the driving force, both the driving forces of the motor 2 and the internal combustion engine driving source 3 are transmitted to the inner rotor 11.

The motor control portion 5 is configured to perform a control for switching the driving source of the oil pump 1 (inner rotor 11) to at least one of the motor 2 and the internal combustion engine driving source 3 based on the oil temperature and the number of rotations of the internal combustion engine (engine). Specifically, the motor control portion 5 is configured to perform the control for turning on and off the OSV 41 of the driving source switching means 4 so as to switch the driving source of the oil pump 1. The motor control portion 5 is also configured to drive or stop the motor 2 upon switching the driving source of the oil pump 1. That is, the motor control portion 5 is configured to drive the motor 2 by conforming to timing at which the driving source of the oil pump 1 is switched to the motor 2 in a case where the driving source of the oil pump 1 is switched to the motor 2 and to stop the motor 2 by conforming to timing at which the driving source of the oil pump 1 is switched to the internal combustion engine driving source 3.

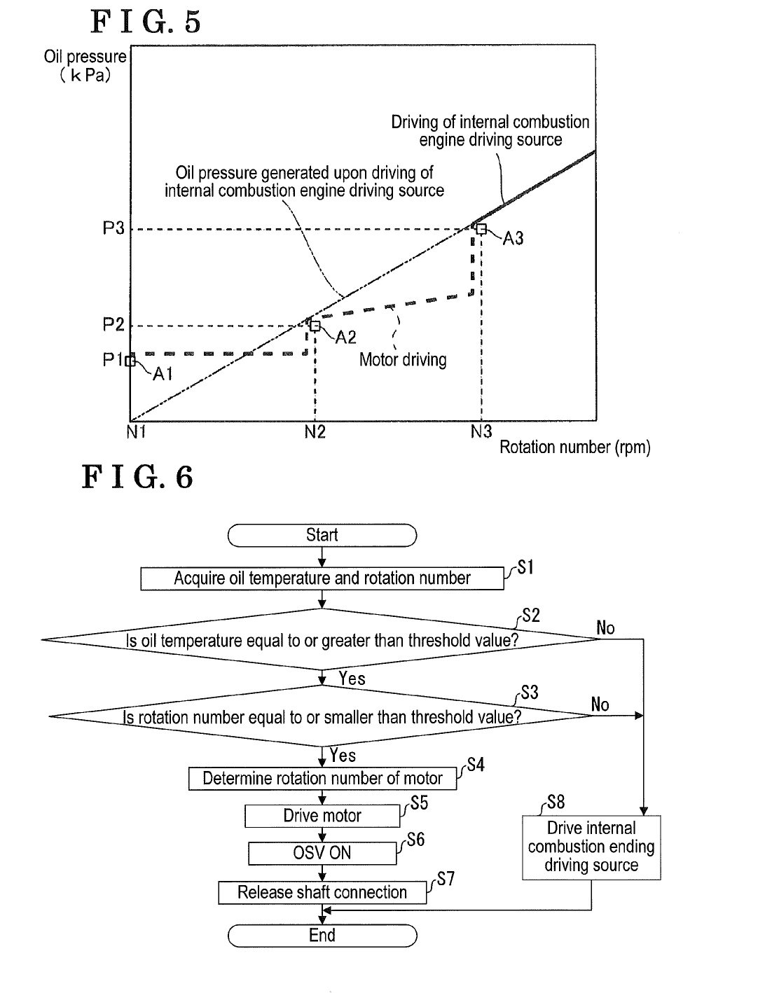

In the first embodiment, the motor control portion 5 is configured to determine a rotation number of the motor 2 based on the oil temperature detected by the oil temperature detection portion 7 and the rotation number of the internal combustion engine detected by the rotation number detection portion 8 in a case where the driving source of the oil pump 1 (inner rotor 11) is switched to the motor 2 by the driving source switching means 4. Specifically, the motor control portion 5 is configured to drive the motor 2 so that a required discharge rate of the engine oil depending on each rotation number illustrated in FIG. 5 is satisfied in a case where the oil temperature is greater than the predetermined temperature (for example, 80° C.) and the rotation number of the internal combustion engine is smaller than the predetermined rotation number (for example, 4000 rpm). For example, the motor control portion 5 drives the motor 2 to achieve an oil pressure P1 required for moving a hydraulic device (for example, a VVT (variable valve timing mechanism)) in a state where idling of the internal combustion engine (engine) is stopped (i.e., in a state of a rotation number N1 (=0)). In addition, the motor control portion 5 drives the motor 2 to achieve an oil pressure P2 required for moving the hydraulic device in a state of A2 (rotation number N2) in FIG. 5. In a region equal to or greater than a rotation number N3 (for example, 4000 rpm), the oil pump 1 is driven by the internal combustion engine driving source 3.

In a case where the driving source of the inner rotor 11 (oil pump 1) is switched from the internal combustion engine driving source 3 to the motor 2 by the driving source switching means 4, the motor control portion 5 is configured to control the OSV 41 to turn on the application of the oil pressure after driving and rotating the motor 2. Specifically, in a case where the driving source of the inner rotor 11 is switched from the internal combustion engine driving source 3 to the motor 2 by the driving source switching means 4, the motor control portion 5 is configured to drive and rotate the motor 2 so that the rotation number of the motor 2 becomes approximate to the rotation number of the internal combustion engine driving source 3 (drive shaft 31) and thereafter to control the OSV 41 to turn on the application of the oil pressure.

The oil temperature detection portion 7 is configured to detect the oil temperature of the engine oil that circulates by the oil pump 1. The detected oil temperature is output to the motor control portion 5. The rotation number detection portion 8 is configured to detect the rotation number of the internal combustion engine (engine). The detected rotation number is output to the motor control portion 5.

Next, a driving source switching process performed by the motor control portion 5 of the first embodiment is explained with reference to FIG. 6.

In step S1, the oil temperature of the engine oil and the rotation number of the internal combustion engine (engine) are acquired. In step S2, it is determined whether or not the oil temperature is equal to or greater than a threshold value (for example, 80° C.). In a case where the oil temperature is smaller than the threshold value, the operation proceeds to step S8. In a case where the oil temperature is equal to or greater than the threshold value, it is determined whether or not the rotation number of the internal combustion engine (engine) is equal to or smaller than a threshold value (for example, 4000 rpm) in step S3.

In a case where the rotation number of the internal combustion engine is greater than the threshold value, the operation proceeds to step S8. In a case where the rotation number of the internal combustion engine is equal to or smaller than the threshold value (for example, 4000 rpm), the rotation number of the motor 2 is determined in step S4. Specifically, as illustrated in FIG. 5, the rotation number of the motor 2 is determined so that the required discharge rate of the engine oil is satisfied depending on the rotation number of the internal combustion engine and the oil temperature of the engine oil. The motor 2 is driven in step S5. Specifically, the motor 2 is driven so that the rotation number of the motor 2 becomes approximate to the rotation number of the internal combustion engine driving source 3.

In step S6, the OSV41 is controlled to be turned on. That is, it is controlled that the oil pressure from the oil ump 1 is applied to the engagement member 42. A shaft connection is released in step S7. That is, as illustrated in FIG. 3, the engagement member 42 moves in the direction A1 to thereby release the connection between the engagement member 42 and the motor shaft 22. Accordingly, the driving source of the oil pump 1 (inner rotor 11) is switched to the motor 2. That is, in a case where the oil temperature of the engine oil is equal to or greater than the threshold value and the number of rotations of the internal combustion engine is equal to or smaller than the threshold value, the driving source of the oil pump 1 (inner rotor 11) is switched to the motor 2. After the driving source is switched to the motor 2, the rotation number of the motor 2 is switched from the rotation number upon switching (the rotation number approximate to the rotation number of the internal combustion engine driving source 3) to the rotation number that is determined in step S4.

In a case where the oil temperature of the engine oil is smaller than the threshold value or the rotation number of the internal combustion engine is greater than the threshold value, the driving source of the oil pump 1 (inner rotor 11) is switched to the internal combustion engine driving source 3 in step S8. Specifically, the OSV41 is controlled to be turned off. As illustrated in FIG. 2, the engagement member 42 moves in the direction A2 so as to engage with the motor shaft 22. Afterwards, the driving source switching process is terminated.

In the first embodiment, as mentioned above, the driving source switching means 4 is provided for switching the driving source of the oil pump 1 to at least one of the motor 2 and the internal combustion engine driving source 3 based on the oil temperature detected by the oil temperature detection portion 7 and the rotation number of the internal combustion engine detected by the rotation number detection portion 8. Thus, even when the oil temperature specified for driving the oil pump 1 by the motor 2 is obtained in a case where the rotation number of the internal combustion engine increases so that the oil discharge rate is required to increase, the switching is made to drive the oil pump 1 by the internal combustion engine driving source 3 based on not only the oil temperature but also the rotation number of the internal combustion engine so that the driving force of the internal combustion engine including the high rotation number is transmitted to drive the oil pump 1 through the internal combustion engine driving source 3. Accordingly, without a usage of a high-power motor that achieves a high revolution, a desired oil discharge rate is obtainable. In addition, in a case where the oil temperature is low and oil viscosity is high such as at the start of the internal combustion engine, for example, the oil pump 1 is switched to be driven by the internal combustion engine driving source 3 based on the oil temperature and the rotation number of the internal combustion engine. Without the usage of a high-torque motor, the desired oil discharge rate is obtainable.

In the first embodiment, as mentioned above, the driving source switching means 4 is configured to switch the driving source of the oil pump 1 to the motor 2 in a case where the oil temperature detected by the oil temperature detection portion 7 is greater than the predetermined temperature and the rotation number of the internal combustion engine detected by the rotation number detection portion 8 is smaller than the predetermined rotation number. Accordingly, the driving source of the oil pump 1 is switched to the motor 2 in a case where the oil temperature is greater than the predetermined temperature so that the oil pump 1 is driven by the motor 2 in a state where the oil temperature is greater than the predetermined temperature and the oil viscosity is lower than a predetermined viscosity. Without a large load applied to the motor 2, the oil pump 1 may be effectively driven. In addition, the driving source of the oil pump 1 is switched to the motor 2 in a case where the rotation number of the internal combustion engine is smaller than the predetermined rotation number so that the oil pump 1 may be effectively driven within an output range of the motor which is effective at a time of low rotation and high output power.

In the first embodiment, as mentioned above, the rotation number of the motor 2 is configured to be determined on a basis of the oil temperature detected by the oil temperature detection portion 7 and the rotation number of the internal combustion engine detected by the rotation number detection portion 8 in a case where the driving source of the oil pump 1 is switched to the motor 2 by the driving source switching means 4. Accordingly, the oil discharge rate based on the detected oil temperature and the detected rotation number of the internal combustion engine may be effectively achieved by the driving of the motor 2.

In the first embodiment, as mentioned above, the driving force of each of the motor 2 and the internal combustion engine driving source 3 is configured to be transmitted to the inner rotor 11 of the oil pump 1. Accordingly, the driving force of each of the motor 2 and the internal combustion engine driving source 3 may be effectively transmitted to the inner rotor 11 to effectively drive the oil pump 1. In addition, because a size in a radial direction of the transmission mechanism may be reduced as compared to a case where the driving force is transmitted to the outer rotor 12, the oil pump driving control apparatus 100 may be downsized.

In the first embodiment, as mentioned above, the motor 2 is constantly connected to the inner rotor so as to rotate together with the inner rotor 11 of the oil pump 1. In a case where the switching is made by the driving source switching means 4 so that the driving force of the internal combustion engine driving source 3 is transmitted to the inner rotor 11, the driving force of the internal combustion engine driving source 3 is transmitted to the inner rotor 11 through the motor 2. In a case where the switching is made by the driving source switching means 4 so that the driving force of the motor 2 is transmitted to the inner rotor 11, the driving force of the motor 2 is directly transmitted to the inner rotor 11 without through the internal combustion engine driving source 3. Accordingly, in a case where the driving force of the motor 2 is switched to be transmitted to the inner rotor 11, the driving of the internal combustion engine driving source 3 is inhibited from being transmitted to the inner rotor 11 and only the driving force of the motor 2 is transmitted to the inner rotor 11. Regardless of the rotation number of the internal combustion engine, the oil pump 1 may be driven by the motor 2. In a case where the driving force of the internal combustion engine driving source 3 is switched to be transmitted to the inner rotor 11, the driving of the internal combustion engine driving source 3 is transmitted to the inner rotor 11 through the motor 2. Thus, the oil pump 1 may be driven by the driving force from the internal combustion engine which is adjusted with the driving force from the motor 2. Accordingly, the oil pump 1 may be effectively driven.

In the first embodiment, as mentioned above, the driving source of the oil pump 1 is configured to be switched to at least one of the motor 2 and the internal combustion engine driving source 3 by the turn-on and turn-off control of the oil pressure by the OSV 41. Accordingly, the driving source of the oil pump 1 is configured to be switched to at least one of the motor 2 and the internal combustion engine driving source 3 by the turn-on and turn-off control of the oil pressure by the OSV 41 so as to arbitrary specify timing at which the driving source is switched.

In the first embodiment, as mentioned above, in a case where the driving source of the oil pump 1 is switched to the internal combustion engine driving source 3 by the driving source switching means 4, the motor 2 is configured to generate the electric power by being rotated together with the oil pump 1 by the internal combustion engine driving source 3. Accordingly, the motor 2 rotating (led to rotate) in association with the driving of the oil pump 1 by the internal combustion engine driving source 3 is usable as a generator. A mechanical energy by the internal combustion engine driving source 3 is partially recovered as an electric energy by the motor 2, and the electric energy that is recovered may be effectively used as a driving electric power for other equipment.

In the first embodiment, as mentioned above, the engagement member 42 is configured to be switched to the first engagement state where the driving force of the motor 2 is transmitted to the oil pump 1 and to the second engagement state where the driving force of the internal combustion engine driving source 3 is transmitted to the oil pump 1. Accordingly, the engagement state of the engagement member 42 is switched to easily switch the driving source of the oil pump 1 to either the internal combustion engine driving source 3 or the motor 2.

In the first embodiment, as mentioned above, the motor 2 is constantly connected to the oil pump 1. In the first engagement state, the engagement member 42 engages with the internal combustion engine driving source 3 and disengages from the motor 2 so that the driving force of the motor 2 is transmitted to the oil pump 1 without through the engagement member 42. In the second engagement state, the engagement member 42 engages with both the motor 2 and the internal combustion engine driving source 3 so that the driving force of the internal combustion engine driving source 3 is configured to be transmitted to the oil pump 1 through the engagement member 42 and the motor 2. Accordingly, in the first engagement state, the driving of the internal combustion engine driving source 3 is inhibited from being transmitted to the oil pump 1 and only the driving force of the motor 2 is transmitted to the oil pump 1. Regardless of the rotation number of the internal combustion engine, the oil pump 1 may be driven by the motor 2. In the second engagement state, the driving of the internal combustion engine driving source 3 is transmitted to the oil pump 1 through the motor 2, so that the oil pump 1 may be driven by the driving force from the internal combustion engine which is adjusted with the driving force from the motor 2. Accordingly, the oil pump 1 may be effectively driven.

In the first embodiment, as mentioned above, in a case where the driving source of the oil pump 1 is switched from the internal combustion engine driving source 3 to the motor 2 by the driving source switching means 4, the driving source of the oil pump 1 is configured to be switched to the motor 2 after the motor 2 is driven to rotate. Accordingly, upon switching of the driving source, the motor 2 is driven to rotate so as to follow the rotation number of the drive shaft 31 of the internal combustion engine driving source 3. A load applied between the drive shaft 31 of the internal combustion engine driving source 3 and the motor shaft 22 of the motor 2 may be reduced, thereby smoothly switching the driving source of the oil pump 1 from the internal combustion engine driving source 3 to the motor 2.

### Second Embodiment

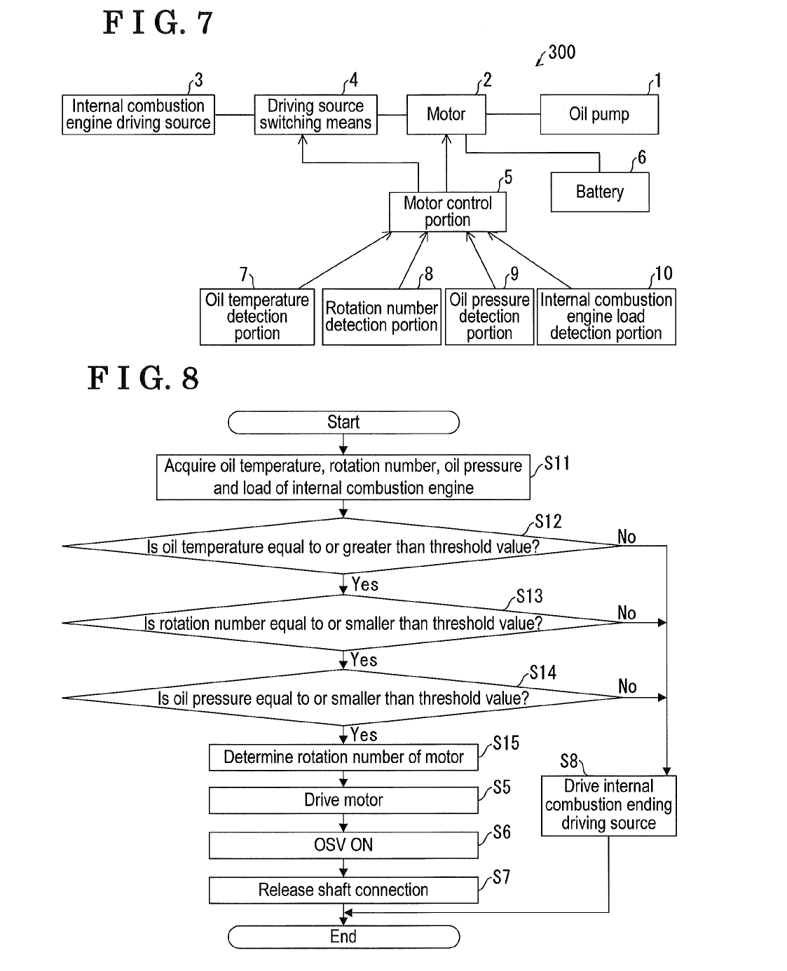

The second embodiment of the present invention is explained with reference to FIGS. 7 and 8. In the second embodiment, an example where the driving source of the oil pump 1 is switched to at least one of the motor 2 and the internal combustion engine driving source 3 based on the oil pressure in addition to the oil temperature and the rotation number of the internal combustion engine, being different from the first embodiment where the driving source of the oil pump 1 is switched to at least one of the motor 2 and the internal combustion engine driving source 3 based on the oil temperature and the rotation number of the internal combustion engine.

An oil pump driving control apparatus 300 according to the second embodiment of the present invention is mounted to an automobile (not illustrated) and is configured to supply and circulate the engine oil to the internal combustion engine (engine) of the automobile. As illustrated in FIG. 7, the oil pump driving control apparatus 300 includes the oil pump 1, the motor 2, the internal combustion engine driving source 3, the driving source switching means 4, the motor control portion 5, the battery 6, the oil temperature detection portion 7, the rotation number detection portion 8, an oil pressure detection portion 9 and an internal combustion engine load detection portion 10. The internal combustion engine load detection portion 10 is an example of a load detection means of the present invention.

Here, in the second embodiment, the driving source switching means 4 is configured to switch the driving source of the oil pump 1 to at least one of the motor 2 and the internal combustion engine driving source 3 based on the oil temperature detected by the oil temperature detection portion 7, the rotation number of the internal combustion engine (engine) detected by the rotation number detection portion 8 and the oil pressure of the engine oil detected by the oil pressure detection portion 9. Specifically, the driving source switching means 4 is configured to switch the driving source of the oil pump 1 to the motor 2 in a case where the oil temperature detected by the oil temperature detection portion 7 is greater than the predetermined temperature (for example, 80° C.), the rotation number of the internal combustion engine detected by the rotation number detection portion 8 is smaller than the predetermined rotation number (for example, 4000 rpm), and the oil pressure detected by the oil pressure detection portion 9 is smaller than a predetermined oil pressure. The predetermined oil pressure may vary depending on the rotation number of the internal combustion engine (engine). In addition, by the detection of the oil pressure of the engine oil, it is possible to detect a difference in viscosity in a case of oil change or a change in viscosity by a usage of engine oil, for example.

The motor control portion 5 is configured to perform a control for switching the driving source of the oil pump 1 (inner rotor 11) to at least one of the motor 2 and the internal combustion engine driving source 3 based on the oil temperature, the rotation number of the internal combustion engine (engine) and the oil pressure.

In the second embodiment, in a case where the driving source of the oil pump 1 (inner rotor 11) is switched to the motor 2 by the driving source switching means 4, the motor control portion 5 is configured to determine the rotation number of the motor 2 based on the oil temperature detected by the oil temperature detection portion 7, the rotation number of the internal combustion engine detected by the rotation number detection portion 8, the oil pressure detected by the oil pressure detection portion 9, and a load of the internal combustion engine detected by the internal combustion engine load detection portion 10. Specifically, in a case where the oil temperature is greater than the predetermined temperature (for example, 80° C.), the rotation number of the internal combustion engine is smaller than the predetermined rotation number (for example, 4000 rpm), and the oil pressure is smaller than the predetermined oil pressure, the motor control portion 5 is configured to drive the motor 2 so that the required discharge rate of the engine oil depending on the rotation number of the internal combustion engine is satisfied in view of the oil pressure (viscosity) of the engine oil and the load of the internal combustion engine as illustrated in FIG. 5. In a case where the load of the internal combustion engine is large, the rotation number of the motor 2 is enlarged so as to increase the volume of engine oil supplied to the internal combustion engine.

The oil temperature detection portion 7 is configured to detect the oil temperature of the engine oil that circulates by the oil pump 1. The detected oil temperature is output to the motor control portion 5. The rotation number detection portion 8 is configured to detect the rotation number of the internal combustion engine (engine). The detected rotation number is output to the motor control portion 5.

The oil pressure detection portion 9 is configured to detect the oil pressure of the engine oil that circulates by the oil pump 1. The detected oil pressure is output to the motor control portion 5. The internal combustion engine load detection portion 10 detects the load of the internal combustion engine (engine) by detecting an accelerator opening degree, a throttle opening degree, a valve lift amount or a fuel injection amount. That is, the internal combustion engine load detection portion 10 detects that the load of the internal combustion engine increases by the opening of the accelerator at an uphill or upon sudden acceleration, and that the load of the internal combustion engine decreases on a downhill, for example.

Next, the driving source switching process performed by the motor control portion 5 of the second embodiment is explained with reference to FIG. 8.

In step S11, the oil temperature of the engine oil, the rotation number of the internal combustion engine (engine), the oil pressure of the engine oil and the load of the internal combustion engine are acquired. In step S12, is it determined whether or not the oil temperature is equal to or greater than a threshold value (for example, 80° C.). In a case where the oil temperature is smaller than the threshold value, the operation proceeds to step S8. In a case where the oil temperature is equal to or greater than the threshold value, it is determined whether or not the rotation number of the internal combustion engine is equal to or smaller than a threshold value (for example, 4000 rpm) in step S13.

In a case where the rotation number of the internal combustion engine is greater than the threshold value, the operation proceeds to step S8. In a case where the rotation number is equal to or smaller than the threshold value (for example, 4000 rpm), it is determined whether or not the oil pressure is equal to or smaller than a threshold value in step S14. In a case where the oil pressure is greater than the threshold value, the operation proceeds to step S8. In a case where the oil pressure is equal to or smaller than the threshold value, the rotation number of the motor 2 is determined in step S15. Specifically, as illustrated in FIG. 5, the rotation number of the motor 2 is determined so that the required discharge rate of the engine oil depending on the oil pressure of the engine oil, the oil temperature, the rotation number of the internal combustion engine and the load of the internal combustion engine is satisfied. The operation is thereafter proceeds to step S5.

The operations in step S5 to S8 are the same as the first embodiment illustrated in FIG. 6.

As mentioned above, also in the construction of the second embodiment, in the same way as the first embodiment, the driving source switching means 4 is provided for switching the driving source of the oil pump 1 to at least one of the motor 2 and the internal combustion engine driving source 3 based on the oil temperature detected by the oil temperature detection portion 7 and the rotation number of the internal combustion engine detected by the rotation number detection portion 8. Accordingly, without a usage of a high-power motor that achieves a high revolution, the desired oil discharge rate is obtainable.

Further, in the second embodiment, as mentioned above, the driving source switching means 4 is configured to switch the driving source of the oil pump 1 to at least one of the motor 2 and the internal combustion engine driving source 3 based on the oil temperature detected by the oil temperature detection portion 7, the rotation number of the internal combustion engine detected by the rotation number detection portion 8 and the oil pressure detected by the oil pressure detection portion 9. Accordingly, the driving of the oil pump 1 is switched on a basis of the detected oil pressure in addition to the detected oil temperature and the detected rotation number of the internal combustion engine. The change in viscosity resulting from oil difference or degradation of oil, for example, is detectable on a basis of the oil pressure. As a result, the driving of the oil pump 1 suitable for the state of the oil may be performed.

In the second embodiment, as mentioned above, the driving source switching means 4 is configured to switch the driving source of the oil pump 1 to the motor 2 in a case where the oil temperature detected by the oil temperature detection portion 7 is greater than the predetermined temperature, the rotation number of the internal combustion engine detected by the rotation number detection portion 8 is lower than the predetermined rotation number, and the oil pressure detected by the oil pressure detection portion 9 is smaller than the predetermined oil pressure. Accordingly, the oil pump 1 may be effectively driven within the effective output range of the motor 2 depending on the state of the oil when the driving source of the oil pump 1 is switched to the motor 2 in a case where the oil pressure is smaller than the predetermined oil pressure. In addition, the driving source of the oil pump 1 is switched to the motor 2 in a case where the oil temperature is greater than the predetermined temperature so that the oil pump 1 is driven by the motor 2 without a large load applied to the motor when the oil temperature is greater than the predetermined temperature and the oil pressure is low. Thus, the oil pump 1 may be effectively driven. Further, the driving source of the oil pump 1 is switched to the motor 2 in a case where the rotation number of the internal combustion engine is smaller than the predetermined rotation number to thereby effectively drive the oil pump 1 within the effective output range of the motor 2.

In the second embodiment, as mentioned above, the rotation number of the motor 2 is configured to be determined on a basis of the oil temperature detected by the oil temperature detection portion 7, the rotation number of the internal combustion engine detected by the rotation number detection portion 8, the oil pressure detected by the oil pressure detection portion 9 and the load of the internal combustion engine detected by the internal combustion engine load detection portion 10 in a case where the driving source of the oil pump 1 is switched to the motor 2 by the driving source switching means 4. Accordingly, the oil discharge rate depending on the detected oil temperature, the detected rotation number of the internal combustion engine, the detected oil pressure and the detected load of the internal combustion engine may be effectively achieved by the driving of the motor 2.

The other effects of the second embodiment are the same as the aforementioned first embodiment.

The embodiments disclosed here should be considered as examples at any point and considered not to be restrictive. The scope of the present invention is indicated by the scope of claims and not indicated by the aforementioned explanations of the embodiments. Further, equivalent meaning to the scope of claims and any changes within the scope of claims are included.

For example, in the aforementioned first and second embodiments, the example where the oil pump driving control apparatus of the present invention circulates the engine oil is explained. The present invention, however, is not limited to the above. In the present invention, for example, the oil pump driving control apparatus may be configured to circulate AT (automatic transmission) fluid, CVT (continuously variable transmission) fluid or oil (fluid) such as power steering fluid and the like.

In the aforementioned first embodiment, the example where the driving source switching means is configured to switch the driving source of the oil pump to the motor in a case where the oil temperature detected by the oil temperature detection portion is greater than the predetermined temperature and the rotation number of the internal combustion engine detected by the rotation number detection portion is smaller than the predetermined rotation number is explained. The present invention, however, is not limited to the above. In the present invention, the driving source switching means may be configured to switch the driving source of the oil pump to the motor in at least one of the cases where the oil temperature detected by the oil temperature detection portion is greater than the predetermined temperature and where the rotation number of the internal combustion engine detected by the rotation number detection portion is smaller than the predetermined rotation number.

In the aforementioned second embodiment, the example where the driving source switching means is configured to switch the driving source of the oil pump to the motor in a case where the oil temperature detected by the oil temperature detection portion is greater than the predetermined temperature, the rotation number of the internal combustion engine detected by the rotation number detection portion is smaller than the predetermined rotation number and the oil pressure detected by the oil pressure detection portion is smaller than the predetermined oil pressure is explained. The present invention, however, is not limited to the above. In the present invention, the driving source switching means may be configured to switch the driving source of the oil pump to the motor in at least one of the cases where the oil temperature detected by the oil temperature detection portion is greater than the predetermined temperature, where the rotation number of the internal combustion engine detected by the rotation number detection portion is smaller than the predetermined rotation number and where the oil pressure detected by the oil pressure detection portion is smaller than the predetermined oil pressure.

In the aforementioned first and second embodiments, the example where the driving forces of the motor and the internal combustion engine driving source are transmitted to the inner rotor of the oil pump is explained. The present invention, however, is not limited to the above. In the present invention, at least one of the driving forces of the motor and the internal combustion engine driving source may be transmitted to the inner rotor of the oil pump. For example, one of the driving forces of the motor and the internal combustion engine driving source may be transmitted to the inner rotor of the oil pump and the other of the driving forces of the motor and the internal combustion engine driving source may be transmitted to the outer rotor of the oil pump.

In the second embodiment, the example where the rotation number of the motor is configured to be determined on a basis of the oil temperature detected by the oil temperature detection portion, the rotation number of the internal combustion engine detected by the rotation number detection portion, the oil pressure detected by the oil pressure detection portion and the load of the internal combustion engine detected by the load detection means in a case where the driving source of the oil pump is switched to the motor by the driving source switching means is explained. The present invention, however, is not limited to the above. In the present invention, the rotation number of the motor may be configured to be determined on a basis of the oil temperature detected by the oil temperature detection portion, the rotation number of the internal combustion engine detected by the rotation number detection portion and the oil pressure detected by the oil pressure detection portion in a case where the driving source of the oil pump is switched to the motor by the driving source switching means.

In the aforementioned first and second embodiments, the example where the trochoidal-type oil pump is employed is explained. The present invention, however, is not limited to the above. In the present invention, for example, an oil pump with an involute tooth profile of an internal contact type including the inner rotor and the outer rotor may be employed.

In the aforementioned first and second embodiments, the example where the oil pump driving control apparatus is mounted to the automobile including the internal combustion engine is explained. The present invention, however, is not limited to the above. For example, the present invention may be applied to the oil pump driving control apparatus which is mounted to an instrument (equipment) other than the vehicle including the internal combustion engine. In addition, as the internal combustion engine (engine), a petrol engine, a diesel engine, a gas engine, and the like may be employed.

In the aforementioned first and second embodiments, for convenience of explanation, the operation of the control portion of the present invention is explained with the flow-driven type of flowchart performing the operation in sequence by following an operation flow. The present invention, however, is not limited to the above. In the present invention, the operation of the control portion may be performed by an event-driven type operation performing the operation per event. In this case, a completely event-driven type or a combination of the event-driven type and the flow-driven type may be acceptable.

### EXPLANATION OF REFERENCE NUMERALS

1 oil pump
2 motor
3 internal combustion engine driving source
4 driving source switching means (driving source switching portion)
7 oil temperature detection portion
8 rotation number detection portion
9 oil pressure detection portion
10 internal combustion engine load detection portion (load detection means)
11 inner rotor
12 outer rotor
41 OSV (driving source switching mechanism, control valve)
42 engagement member
100, 300 oil pump driving control apparatus

1. An oil pump driving control apparatus comprising:
an internal combustion engine driving source transmitting a driving force of an internal combustion engine to an oil pump that includes an inner rotor and an outer rotor;
a motor separately provided from the internal combustion engine driving source and driving and rotating the oil pump;
an oil temperature detection portion detecting an oil temperature;
a rotation number detection portion detecting a rotation number of the internal combustion engine; and
a driving source switching portion switching a driving source of the oil pump to at least one of the motor and the internal combustion engine driving source based on the oil temperature detected by the oil temperature detection portion and the rotation number of the internal combustion engine detected by the rotation number detection portion.

2. The oil pump driving control apparatus according to claim 1, wherein the driving source switching portion is configured to switch the driving source of the oil pump to the motor in at least one of cases where the oil temperature detected by the oil temperature detection portion is greater than a predetermined temperature and where the rotation number of the internal combustion engine detected by the rotation number detection portion is smaller than a predetermined rotation number.

3. The oil pump driving control apparatus according to claim 2, wherein in a case where the driving source of the oil pump is switched to the motor by the driving source switching portion, a rotation number of the motor is configured to be determined on a basis of the oil temperature detected by the oil temperature detection portion and the rotation number of the internal combustion engine detected by the rotation number detection portion.

4. The oil pump driving control apparatus according to claim 1, further comprising an oil pressure detection portion detecting an oil pressure, wherein the driving source switching portion is configured to switch the driving source of the oil pump to at least one of the motor and the internal combustion engine driving source based on the oil temperature detected by the oil temperature detection portion, the rotation number of the internal combustion engine detected by the rotation number detection portion and the oil pressure detected by the oil pressure detection portion.

5. The oil pump driving control apparatus according to claim 4, wherein the driving source switching portion is configured to switch the driving source of the oil pump to the motor in at least one of cases where the oil temperature detected by the oil temperature detection portion is greater than a predetermined temperature, where the rotation number of the internal combustion engine detected by the rotation number detection portion is smaller than a predetermined rotation number and where the oil pressure detected by the oil pressure detection portion is smaller than a predetermined oil pressure.

6. The oil pump driving control apparatus according to claim 5, wherein in a case where the driving source of the oil pump is switched to the motor by the driving source switching portion, a rotation number of the motor is configured to be determined on a basis of the oil temperature detected by the oil temperature detection portion, the rotation number of the internal combustion engine detected by the rotation number detection portion and the oil pressure detected by the oil pressure detection portion.

7. The oil pump driving control apparatus according to claim 6, further comprising a load detection portion detecting a load of the internal combustion engine, wherein the rotation number of the motor is configured to be determined on a basis of the oil temperature detected by the oil temperature detection portion, the rotation number of the internal combustion engine detected by the rotation number detection portion, the oil pressure detected by the oil pressure detection portion and the load of the internal combustion engine detected by the load detection portion.

8. The oil pump driving control apparatus according to claim 1, wherein at least one of the driving force of the internal combustion engine driving source and a driving force of the motor is configured to be transmitted to the inner rotor of the oil pump.

9. The oil pump driving control apparatus according to claim 8, wherein the motor is constantly connected to the inner rotor to rotate with the inner rotor of the oil pump,
the driving force of the internal combustion engine driving source is configured to be transmitted to the inner rotor through the motor in a case where the driving force of the internal combustion engine driving source is switched to be transmitted to the inner rotor by the driving source switching portion,
the driving force of the motor is configured to be directly transmitted to the inner rotor without through the internal combustion engine driving source in a case where the driving force of the motor is switched to be transmitted to the inner rotor by the driving source switching portion.

10. The oil pump driving control apparatus according to claim 1, wherein the driving source switching portion includes a hydraulic driving source switching mechanism.

11. The oil pump driving control apparatus according to claim 10, wherein the driving source switching mechanism includes a control valve that turns on and off an oil pressure from the oil pump, and the driving source of the oil pump is configured to be switched to at least one of the motor and the internal combustion engine driving source by a control for turning on and off the oil pressure by the control valve.

12. The oil pump driving control apparatus according to claim 1, wherein in a case where the driving source of the oil pump is switched to the internal combustion engine driving source by the driving source switching portion, the motor is configured to generate an electric power by being rotated together with the oil pump by the internal combustion engine driving source.

13. The oil pump driving control apparatus according to claim 1, wherein the driving source switching portion includes an engagement member engageable with the internal combustion engine driving source and the motor, the engagement member being configured to be switched to a first engagement state in which one of the driving forces of the motor and the internal combustion engine driving source is transmitted to the oil pump and to a second engagement state in which the other of the driving forces of the motor and the internal combustion engine driving source is transmitted to the oil pump.

14. The oil pump driving control apparatus according to claim 13, wherein the motor is constantly connected to the oil pump,
the driving force of the motor is configured to be transmitted to the oil pump without through the engagement member in the first engagement state in which the engagement member engages with the internal combustion engine driving source and disengages from the motor,
the driving force of the internal combustion engine driving source is configured to be transmitted to the oil pump through the engagement member and the motor in the second engagement state in which the engagement member engages with both the motor and the internal combustion engine driving source.

15. The oil pump driving control apparatus according to claim 1, wherein in a case where the driving source of the oil pump is switched from the internal combustion engine driving source to the motor by the driving source switching portion, the driving source of the oil pump is configured to be switched to the motor after the motor is driven to rotate.
